(19) United States
(12) Patent Application Publication
(10) Pub. No.: US 2019/0107045 A1
(43) Pub. Date: Apr. 11, 2019

(54) MULTI-LAYER THERMAL BARRIER

(71) Applicant: GM GLOBAL TECHNOLOGY OPERATIONS LLC, Detroit, MI (US)

(72) Inventors: Russell P. Durrett, Bloomfield Hills, MI (US); Paul M. Najt, Bloomfield Hills, MI (US); Peter P. Andruskiewicz, IV, Ann Arbor, MI (US)

(21) Appl. No.: 15/730,531

(22) Filed: Oct. 11, 2017

(51) Int. Cl. F02B 77/11; F02F 11/00; B22F 7/08; B32B 15/04

(52) U.S. Cl. CPC F02B 77/11; B32B 15/043; B22F 7/08; F02F 11/005

(57) ABSTRACT

A multi-layer thermal barrier may be applied to a surface of components within an internal combustion engine. The multi-layer thermal barrier provides low thermal conductivity and low heat capacity insulation that is sealed against combustion gasses. The multi-layer thermal barrier includes two, three, or more layers, bonded to one another, e.g., a first (bonding) layer, a second (insulating) layer, and a third (sealing) layer. The insulating layer is disposed between the bonding layer and the sealing layer. The bonding layer is bonded to the component. The insulating layer includes hollow microstructures that may be sintered together to form insulation that provides a low effective thermal conductivity and low effective heat capacity. The sealing layer may be formed of a ceramic material, and the insulating layer may include deformed microstructures having a greater width than height.

### STATEMENT REGARDING FEDERALLY FUNDED RESEARCH OR DEVELOPMENT

This invention was made with government support under contract no. DE-EE0007754 awarded by the United States Department of Energy. The government has certain rights in the invention.

### TECHNICAL FIELD

The disclosure relates generally to a multi-layer thermal barriers, which may be referred to as thermal barrier coatings (TBCs), for protecting components subject to high-temperature gases.

### INTRODUCTION

Internal combustion engines include a plurality of cylinders, a plurality of pistons, at least one intake port, and at least one exhaust port. The cylinders each include surfaces that define a combustion chamber. One or more surfaces of the internal combustion engine may be coated with thermal barrier coatings, or multi-layer thermal barriers, to improve the heat transfer characteristics of the internal combustion engine.

### SUMMARY

A multi-layer thermal barrier, which may be referred to as a composite thermal barrier coating (TBC), may be applied to a surface of or more components within an internal combustion engine. The multi-layer thermal barrier is bonded to the components of the engine to provide low thermal conductivity and low heat capacity insulation that is sealed against combustion gasses.

The multi-layer thermal barrier may include two, three, or more layers, bonded to one another, e.g., a first (bonding) layer, a second (insulating) layer, and a third (sealing) layer. The insulating layer is disposed between the bonding layer and the sealing layer. The bonding layer is bonded to the component and to the insulating layer.

The insulating layer may comprise hollow microstructures that are sintered together to form insulation that provides a low effective thermal conductivity and low effective heat capacity. In some forms, the hollow microstructures are deformed into a flattened shape to increase the contact area and thus increase the bonding between the individual microstructures. Deforming the hollow microstructures also creates smooth surfaces on the insulating layer, resulting in increased contact with the adjacent layers.

The sealing layer is a thin film that is configured to resist the high temperatures, present within the engine. The sealing layer is impermeable to gasses and presents a smooth surface. In some forms, the sealing layer may be substantially comprised of ceramic. In some forms, the sealing layer may be formed of a compressed top layer of the hollow microstructures.

The multi-layer thermal barrier has a low thermal conductivity to reduce heat transfer losses and a low heat capacity so that the surface temperature of the multi-layer thermal barrier tracks the gas temperature in the combustion chamber. Thus, the multi-layer thermal barrier allows surface temperatures of the component to swing with the gas temperatures. This reduces heat transfer losses without affecting the engine's breathing capability and without increasing knocking tendency. Further, heating of cool air entering the cylinder of the engine is reduced. Additionally, exhaust temperature is increased, resulting in faster catalyst light off time and improved catalyst activity.

In one form, which may be combined with or separate from the other forms described herein, a multi-layer thermal barrier is provided that includes at least an insulating layer and a sealing layer. The insulating layer includes a plurality of hollow microstructures bonded together, and the sealing layer is bonded to the insulating layer. The sealing layer is non-permeable and configured to seal against the insulating layer. The sealing layer may comprises a ceramic material or a metal.

In another form, which may be combined with or separate from the other forms disclosed herein, a multi-layer thermal barrier is provided that also includes at least an insulating layer and a sealing layer. The insulating layer includes a plurality of deformed hollow microstructures. Each deformed hollow microstructure has a width greater than its height. The plurality of deformed hollow microstructures are bonded together. The sealing layer is bonded to the insulating layer, the sealing layer being non-permeable and configured to seal against the insulating layer.

In yet another form, which may be combined with or separate from the other forms disclosed herein, a method of forming a thermal barrier for use on a component of an internal combustion engine is provided. The method includes providing a plurality of hollow microstructures, each having a diameter in the range of about 10 microns to about 50 microns to create an insulating layer. The method further includes applying a force to the insulating layer until each of the microstructures is deformed into a flattened hollow microstructure having a width and a height, the width being greater than the height.

Additional features may optionally be provided, including but not limited to the following: the sealing layer comprising a ceramic material; wherein the ceramic material includes at least one of the following: zirconia, partially stabilized zirconia, silicon nitride, fused silica, and barium-neodymium-titanate (BNT); wherein the sealing layer is substantially comprised of the ceramic material; further comprising a bonding layer configured to be bonded to a metal substrate; the insulating layer being bonded to the bonding layer; wherein the bonding layer comprises at least one of a copper based material, a zinc based material, and an alloy comprising copper and zinc; wherein each of the plurality of hollow microstructures comprises at least one of a nickel based material and an iron based material; wherein a thickness of the sealing layer is not greater than 5 microns; wherein the insulating layer has a thickness of between 75 and 300 microns; wherein each microstructure of the plurality of microstructures has a width not greater than 100 μm; wherein the insulating layer has a porosity of at least 90% or at least 95%; each hollow microstructure being flattened and having a width and a height; the width being greater than the height; a majority of an exterior surface area of each deformed hollow microstructure being bonded to an adjacent deformed hollow microstructure; each deformed hollow microstructure having a generally cuboid shape.

Further additional features may be provided, including but not limited to the following: wherein the step of applying the force includes rolling a heated roller against the multi-layer thermal barrier to deform the plurality of hollow microstructures; wherein the step of applying the force includes compressing the plurality of hollow microstructures with a ram and a forming die to deform the plurality of hollow microstructures; wherein the step of applying the force includes applying a vacuum force to the plurality of hollow microstructures to deform the plurality of hollow microstructures; the method further including disposing the insulating layer onto a bonding layer; wherein the bonding layer is applied to a portion of the insulating layer disposed opposite the sealing layer; disposing a sealing layer onto the insulating layer; and heating the insulating layer, the bonding layer, and the sealing layer.

Furthermore, a component comprising a metal substrate presenting a surface may be provided, with version of the multi-layer thermal barrier being bonded to the surface. Furthermore, the present disclosure contemplates an internal combustion engine comprising such a component having any version of multi-layer thermal barrier disposed thereon or bonded thereto, wherein the component is configured to be subjected to combustion gasses.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic, diagrammatic view of a vehicle illustrating a side view of a single cylinder internal combustion engine having a multi-layer thermal barrier disposed on a plurality of components, in accordance with the principles of the present disclosure;

FIG. 2 is a schematic cross-sectional side view of the multi-layer thermal barrier disposed on the components of FIG. 1, according to the principles of the present disclosure;

FIG. 3 is a schematic cross-sectional side view of another example of the multi-layer thermal barrier disposed on the components of FIG. 1, according to the principles of the present disclosure;

FIG. 4 is a schematic cross-sectional side view of yet another example of the multi-layer thermal barrier disposed on the components of FIG. 1, in accordance with the principles of the present disclosure;

FIG. 5A is a schematic cross-sectional side view illustrating one example of a method of forming a multi-layer thermal barrier, according to the principles of the present disclosure; and

FIG. 5B is a schematic cross-sectional side view illustrating another example of a method of forming a multi-layer thermal barrier, according to the principles of the present disclosure.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims.

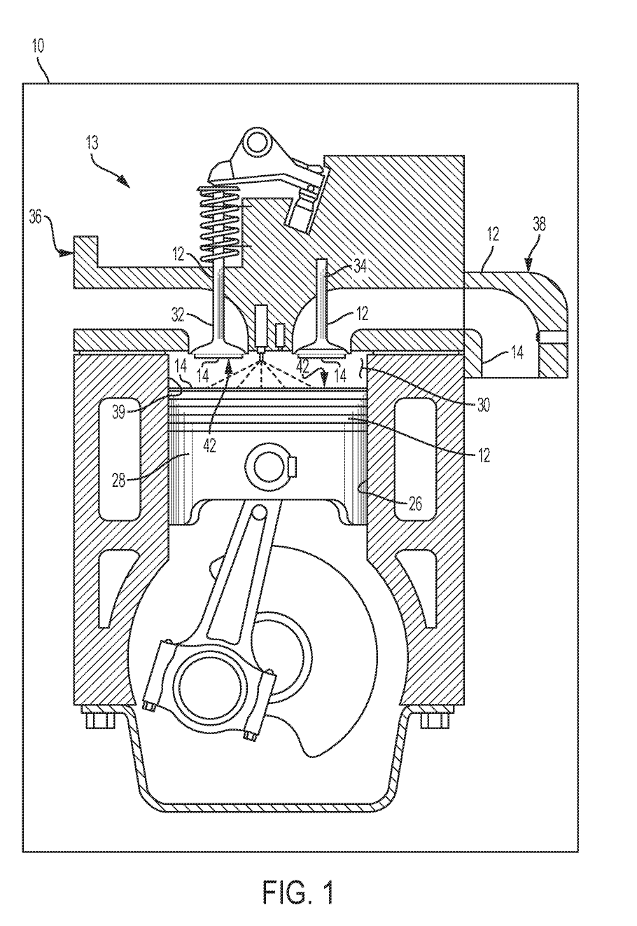

Referring to the drawings, wherein like reference numbers refer to like components throughout the views, FIG. 1 shows a portion of an example vehicle 10. The vehicle 10 may include an engine 13 having a component 12. The component 12 has a composite (multi-layer) thermal barrier “coating” 14 of the type disclosed herein, applied thereto. The multi-layer thermal barrier 14 may be referred to as a composite thermal barrier coating (TBC); it is actually an engineered surface comprised of a plurality of layers, which is described in further detail below.

While the vehicle 10 and the engine 13 of FIG. 1 are a typical example application suitable for the multi-layer thermal barrier 14 disclosed herein, the present design is not limited to vehicular and/or engine applications. Stationary or mobile, machine or manufacture, in which a component thereof is exposed to heat, may benefit from use of the present design. For illustrative consistency, the vehicle 10 and engine 13 will be described hereinafter as an example system, without limiting use of the multi-layer thermal barrier 14 to such an example.

FIG. 1 illustrates an engine 13 defining a single cylinder 26. However, those skilled in the art will recognize that the present disclosure may also be applied to components 12 of engines 13 having multiple cylinders 26. Each cylinder 26 defines a combustion chamber 30. The engine 13 is configured to provide energy for propulsion of the vehicle 10. The engine 13 may include but is not limited to a diesel engine or a gasoline engine.

The engine 13 further includes an intake assembly 36 and an exhaust manifold 38, each in fluid communication with the combustion chamber 30. The engine 13 includes a reciprocating piston 28, slidably movable within the cylinder 26.

The combustion chamber 30 is configured for combusting an air/fuel mixture to provide energy for propulsion of the vehicle 10. Air may enter the combustion chamber 30 of the engine 13 by passing through the intake assembly 36, where airflow from the intake manifold into the combustion chamber 30 is controlled by at least one intake valve 32. Fuel is injected into the combustion chamber 30 to mix with the air, or is inducted through the intake valve(s) 32, which provides an air/fuel mixture. The air/fuel mixture is ignited within the combustion chamber 30. Combustion of the air/fuel mixture creates exhaust gas, which exits the combustion chamber 30 and is drawn into the exhaust manifold 38. More specifically, airflow (exhaust flow) out of the combustion chamber 30 is controlled by at least one exhaust valve 34.

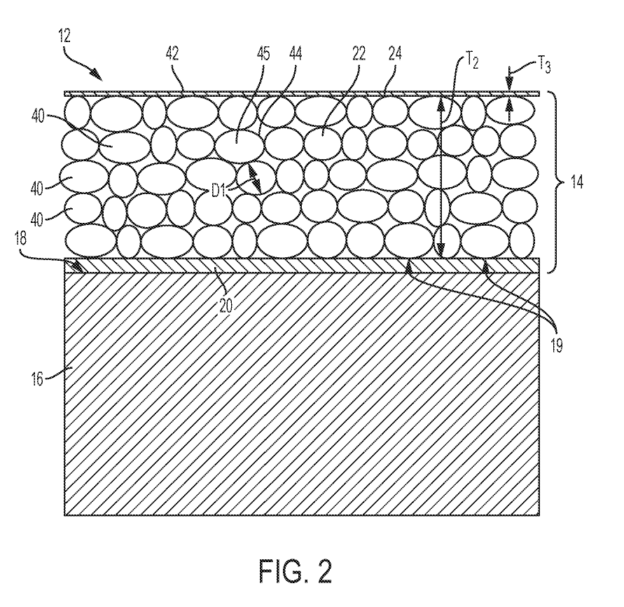

With reference to FIGS. 1 and 2, the multi-layer thermal barrier 14 may be disposed on a face or surface of one or more of the components 12 of the engine 13, e.g., the piston 28, the intake valve 32, exhaust valve 34, interior walls of the exhaust manifold 38 and/or the combustion dome 39, and the like. The multi-layer thermal barrier 14 is bonded to the component 12 to form an insulator configured to reduce heat transfer losses, increase efficiency, and increase exhaust gas temperature during operation of the engine 13. The multi-layer thermal barrier 14 is configured to provide low thermal conductivity and low heat capacity. As such, the low thermal conductivity reduces heat transfer losses and the low heat capacity means that the surface of the multi-layer thermal barrier 14 tracks with the temperature of the gas during temperature swings, and heating of cool air entering the cylinder is minimized.

Referring to FIG. 2, each component 12 includes a substrate 16 presenting a surface 18, and the multi-layer thermal barrier 14 is bonded to the surface 18 of the substrate 16. The multi-layer thermal barrier 14 may include three layers, e.g., a first (bonding) layer 20, a second (insulating) layer 22, and a third (sealing) layer 24. However, depending on the material provided, it should be appreciated that in some embodiments, the multi-layer thermal barrier 14 may not include the first bonding layer 20, because an outer portion of the insulating layer 22 may be configured to bond directly to the substrate 16. For example, when the insulating layer 22 includes nickel (Ni) and the substrate 16 includes iron (Fe), the first layer 20 may not be required. In addition, the multi-layer thermal barrier 14 may include more than three layers, if desired.

The insulating layer 22 includes a plurality of hollow microstructures 40, sintered together to create a layer having an extremely high porosity. Preferably, the porosity of the insulating layer 22 is at least 80%. More preferably, the porosity of the insulating layer 22 is at least 95%. The high porosity provides for a corresponding volume of air and/or gases to be contained therein, thus providing the desired insulating properties of low effective thermal conductivity and low effective heat capacity. The thickness T2 of the insulating layer 22 is between 100 microns (μm) and 1 millimeter (mm). More preferably, the thickness T2 of the insulating layer 22 is between 100 and 500 μm. Even more preferably, the thickness T2 of the insulating layer 22 is between 100 and 300 μm.

The insulating layer 22 is configured to withstand pressures of at least 80 bar. More preferably, the insulating layer 22 is configured to withstand pressures of at least 100 bar. Even more preferably, the insulating layer 22 is configured to withstand pressures of at least 150 bar. Additionally, with respect to temperature, the insulating layer 22 is configured to withstand surface temperatures of at least 500 degrees Celsius (° C.). More preferably, the insulating layer 22 is configured to withstand temperatures of at least 800° C. Even more preferably, the insulating layer 22 is configured to withstand temperatures of at least 1,100° C. The heat capacity of the multi-layer thermal barrier 14 may be configured to ensure that the surface 18 of the substrate 16 does not get above 300° C.

In one example, the hollow microstructures 40 may be comprised of hollow polymer, metal, glass, and/or ceramic centers 45, which may be, or may start off as being, spherical in shape. At least one metallic coating layer 44 may be disposed on an exterior surface of each hollow center 45; in some cases, a first metal coating may be overcoated with a second metal coating. The metallic coating layer 44 may include nickel (Ni), iron, or the like, alone or in combination. The metallic coating layer 44 may be disposed on the exterior surface of the microstructures 40 via electroplating, flame spraying, painting, electroless plating, vapor deposition, or the like.

It should be appreciated that during the bonding or sintering of the metallic coated microstructures 40, the hollow centers 45 that are comprised of polymer, metal, and glass having a melting temperature that is less than that of the metallic coating layer 44, and therefore, the hollow centers 45 may melt or otherwise disintegrate to become part of the metallic coating layer 44 itself, or melt and turn into a lump of material within the hollow microstructure 40. However, when the melting temperature of the hollow center 45 is higher than the melting temperature of the material of the metallic coating layer 44, such as when the hollow center 45 is formed from a ceramic material, the hollow center 45 remains intact and does not disintegrate or become absorbed.

In instances where the hollow centers 45 are formed from polymer, metal, and glass, the hollow center 45 may melt as a function of a material properties of the hollow center 45 and a sintering temperature applied to the microstructures 40. Therefore, when melting of the hollow centers 45 occurs, the inner metallic coating layer 44A is no longer a “coating”, but rather becomes an inner wall 46 of the microstructure 40.

In examples where the microstructures 40 are round, such as shown in FIG. 2, the hollow microstructures 40 may have a diameter D1 of between 5 and 100 μm, between 20 and 100 μm, or between 20-40 μm, by way of example. It should be appreciated that the microstructures 40 do not necessarily have the same diameter, as a mixture of diameters may be configured to provide a desired open porosity, e.g., packing density, to provide a desired amount of strength to the insulating layer 22.

A plurality of the hollow microstructures 40 may be molded or sintered at a sintering temperature, under pressure, for a molding time, until bonds are formed between the coating layers 44 of adjacent hollow microstructures 40 forming the insulating layer 22. The sintering temperature may approach the melting temperature of the metallic coating layer 44. However, in the case where the hollow centers 45 are comprised of ceramic material, the sintering temperature will not be below the melting temperature of the metal coated centers 45.

The bonding layer 20 is configured to bond to the surface 18 of the substrate 16 and to the insulating layer 22, such that the insulating layer 22 is attached to the substrate 16. In one non-limiting example, the bonding layer 20 is configured to diffuse into the surface 18 of the substrate 16 and into the insulating layer 22 to form bonds there between. In one non-limiting example, the substrate 16 comprises aluminum, the insulating layer 22 comprises nickel-coated microstructures 40, and the bonding layer 20 comprises brass, i.e., a copper-zinc (Cu—ZN) alloy material. The Cu—Zn content is determined to create optimum bonding strength, optimum thermal expansion characteristics, heat treatment processes, fatigue resistance, and the like. The copper and zinc have good solid solubility in aluminum, nickel, and iron, while iron and nickel have very low solid solubility in aluminum. Thus, a bonding layer 20 having copper and zinc combinations provides an intermediate structural layer that promotes diffusion bonding between the adjacent aluminum substrate 16 and the adjacent nickel or iron insulating layer 22. It should be appreciated, however, that the substrate 16, insulating layer 22, and bonding layer 20 are not limited to aluminum, nickel, and brass, but may comprise other materials.

One side of the bonding layer 20 may be disposed across the surface 18 of the substrate 16, such that the bonding layer 20 is disposed between the substrate 16 and the insulating layer 22. A compressive force may be applied to the insulating layer 22 and the substrate 16, at a bonding temperature, for at least a minimum apply time. The melting temperature of the material of the bonding layer 20 is less than the melting temperature of each of the substrate 16 and the material of the insulating layer 22. In another example, the melting temperature of the material of the bonding layer 20 is between the melting temperature of each of the substrate 16 and the material of the insulating layer 22. Further, the required bonding temperature may be less than the melting temperature of the material of the substrate 16 and the material of the insulating layer 22, but sufficiently high enough to encourage diffusion bonding to occur between the metallic material of the substrate 16 and the metallic material of the bonding layer 20 and between the metallic material of the bonding layer 20 and the metallic material of the insulating layer 22.

It should be appreciated that the bonding layer 20 may be bonded to an inner surface of the insulating layer 22 prior to bonding the bonding layer 20 to the surface 18 of the substrate 16. Additionally, the bonding layer 20 is not limited to being bonded to the surface 18 of the substrate 16 and/or the insulating layer 22 with solid-state diffusion, as other methods of adhesion may also be used, such as by wetting, brazing, and combinations thereof.

It should be appreciated that a desired number of bonding layers 20 may be applied, providing the desired characteristics, so long as the bonding layer 20 bonds to the insulating layer 22 and to the substrate 16.

The sealing layer 24 is disposed over the insulating layer 22, such that the insulating layer 22 is disposed between the sealing layer 24 and the bonding layer 20. The sealing layer 24 is a high temperature, thin film. More specifically, the sealing layer 24 comprises material that is configured to withstand temperatures of at least 1,100° C. In some forms, the sealing layer 24 may be formed of a metallic material, such as nickel, iron, a nickel alloy, or any other desired metal. In some variations, the sealing layer 24 may comprise a ceramic material, and/or the sealing layer 24 may be substantially comprised of a ceramic material or comprised solely of a ceramic material. When the sealing layer 24 contains a ceramic material, the ceramic material may include zirconia, partially stabilized zirconia, silicon nitride, fused silica, barium-neodymium-titanate (BNT), any other desired ceramic, or combinations of these or other ceramics.

The sealing layer 24 is configured to be thin, e.g., a thickness T3 not greater than 20 μm. More preferably, the sealing layer 24 is configured to have a thickness T3 of not greater than 5 μm. The sealing layer 24 is non-permeable to combustion gases, such that a seal is provided between the sealing layer 24 and the insulating layer 22. Such a seal prevents debris from combustion gases, such as unburned hydrocarbons, soot, partially reacted fuel, liquid fuel, and the like, from entering the porous structure defined by the hollow microstructures 40. If such debris were allowed to enter the porous structure, air disposed in the porous structure would end up being displaced by the debris, and the insulating properties of the insulating layer 22 would be reduced or eliminated.

The sealing layer 24 may be configured to present an outer surface 42 that is smooth. Having a smooth sealing layer 24 may be important to prevent the creation of turbulent airflow as the air flows across the outer surface 42 of the sealing layer 24. Further, having a sealing layer 24 with a smooth surface prevents an increased heat transfer coefficient. In one non-limiting example, the sealing layer 24 may be applied to the insulating layer 22 via electroplating or vapor deposition. In another non-limiting example, the sealing layer 24 may be applied to the insulating layer 22 simultaneously with sintering the insulating layer 22.

The sealing layer 24 is configured to be sufficiently resilient so as to resist fracturing or cracking during exposure to combustion gases, thermal fatigue, or debris. Further, the sealing layer 24 is configured to be sufficiently resilient so as to withstand expansion and/or contraction of the underlying insulating layer 22.

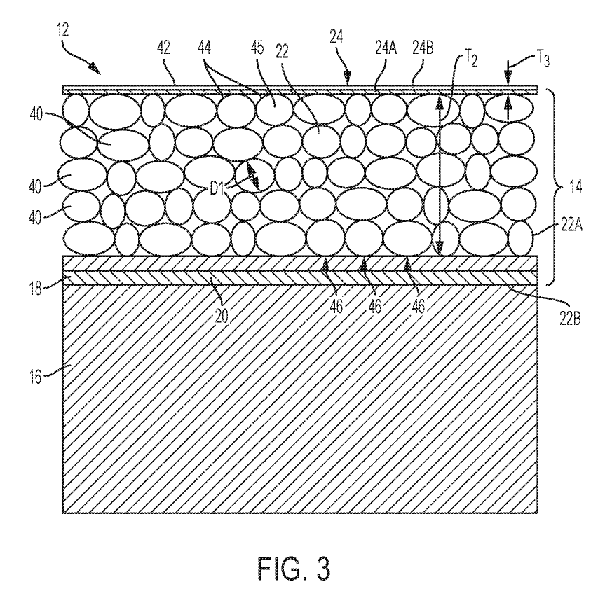

Referring now to FIG. 3, the insulating layer 22 may include more than one layer. More specifically, the insulating layer 22 may include a microstructure layer 22A and a transition layer 22B. The microstructure layer 22A is a layer comprising the plurality of hollow microstructures 40, bonded together, as described above. The transition layer 22B may comprise nickel or iron, by way of example. In some examples, the metallic material of the transition layer 22B and the coating for the microstructures 40 of the microstructure layer 22A may be identical to promote bonding between the layers 22A, 22B. As such, the microstructures 40 on a periphery of the microstructure layer 22A are bonded to the transition layer 22B when the microstructure layer 22A and the transition layer 22B are heated to a temperature sufficient to sinter the microstructure layer 22A to the transition layer 22B.

The microstructure layer 22A is preferably formed to have a thickness T2 of between 100 μm and 1 mm, between 100 and 500 μm, or between 100 and 300 μm, by way of example. The microstructure layer 22A is configured to withstand pressures of at least 150 bar and to withstand surface temperatures of at least 1,100° C.

The transition layer 22B bonds to the coating 44 of the individual microstructures 40 at points of contact 46. The transition layer 22B provides a supporting structure or backbone for the microstructure layer 22A, thus giving the insulating layer 22 strength and rigidity. Upon the application of heat to the transition layer and the bonding layer, for a sufficient amount of time, metal diffusion occurs between the bonding layer 20 and the substrate 16 and between the bonding layer 20 and the transition layer 22B of the insulating layer 22. The transition layer 22B provides greater surface area contact to the bonding layer 20 for promoting a larger area of diffusion bonding, than when the transition layer 22B is not used, and the microstructures 40 of the microstructure layer 22A diffusion bond directly to the bonding layer 20 (as shown in FIG. 2).

Referring again to FIG. 3, the sealing layer 24 may also include more than one layer. More specifically, the sealing layer 24 may include a first barrier layer 24A and a second barrier layer 24B. The first barrier layer 24A may be disposed on the insulating layer 22, and the second barrier layer 22B may be disposed on the first barrier layer 24A, such that the first barrier layer 24A is disposed between the second barrier layer 24B and the insulating layer 22. The second barrier layer 24B may be configured to present the outer surface 42 that is smooth.

The first barrier layer 24A and the second barrier layer 24B may be layered upon one another to provide desired properties, e.g., super-high temperature resistance, corrosion resistance. In one non-limiting example, the second barrier layer 24B provides corrosion resistance and super-high temperature resistance, while the first barrier layer 24A provides a seal against the underlying insulating layer 22 to prevent debris from entering open spaces defined between microstructures 40 of the underlying insulating layer 22. Any desired number of sealing layers 24 may be applied. A thickness T3 of the sealing layer 24, regardless of the number of component barrier layers, is preferably not greater than 20 μm, or even more preferably not greater than 5μm.

Each of the first barrier layer 24A and the second barrier layer 24B of the sealing layer 24 may be formed of metal or ceramic, as described above with reference to the sealing layer 24 shown in FIG. 2.

Further, the bonding, insulating, and sealing layers 20, 22, 24 are each configured to have compatible coefficient of thermal expansion characteristics to withstand thermal fatigue.

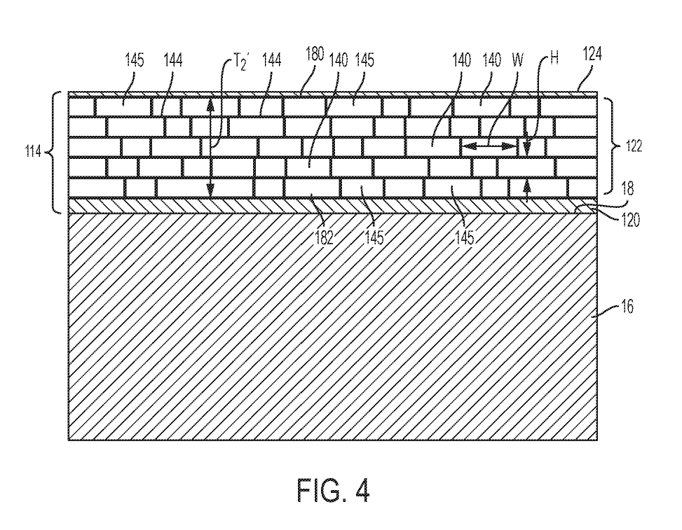

Referring now to FIG. 4, another variation of a multi-layer thermal barrier within the spirit and scope of the present disclosure is illustrated and generally designated at 114. The multi-layer thermal barrier 114 may be similar in all respects to the multi-layer thermal barrier 14 shown above, except as described herein with respect to the insulating layer 122. Thus, the multi-layer thermal barrier 114 optionally has a bonding layer 120 disposed on the surface 18 of a substrate 16 that may be similar to or the same as the bonding layers 20 described above in FIGS. 2 and 3. Likewise, the multi-layer thermal barrier 114 has a sealing layer 124 that may be the same as or similar to the sealing layer 24 shown and described above with respect to FIGS. 2 and 3.

The difference in the multi-layer thermal barrier 114 of FIG. 4 lies in the insulating layer 122, but the insulating layer 122 also has some similarities to the insulating layer 22 described above. Like the insulating layer 22, the insulating layer 122 in FIG. 4 includes a plurality of hollow microstructures 140, sintered together to create a layer having an extremely high porosity.

Preferably, the porosity of the insulating layer 122 is at least 80%. More preferably, the porosity of the insulating layer 122 is at least 90%. Even more preferably, the porosity of the insulating layer 122 is at least 95%. As described above, the high porosity provides for a corresponding volume of air and/or gases to be contained therein, thus providing the desired insulating properties of low effective thermal conductivity and low effective heat capacity.

The thickness T2′ of the insulating layer 122 is between about 75 microns (μm) and 1 millimeter (mm). More preferably, the thickness T2′ of the insulating layer 122 is between 75 and 500 μm. Even more preferably, the thickness T2′ of the insulating layer 122 is between 75 and 300 μm.

The insulating layer 122 is configured to withstand pressures of at least 80 bar. More preferably, the insulating layer 122 is configured to withstand pressures of at least 100 bar. Even more preferably, the insulating layer 122 is configured to withstand pressures of at least 150 bar. Additionally, with respect to temperature, the insulating layer 122 is configured to withstand surface temperatures of at least 500 degrees Celsius (° C.). More preferably, the insulating layer 122 is configured to withstand temperatures of at least 800° C. Even more preferably, the insulating layer 122 is configured to withstand temperatures of at least 1,100° C. The heat capacity of the multi-layer thermal barrier 114 may be configured to ensure the surface 18 of the substrate 16 does not get above 300° C.

Like the hollow microstructures 40 described above, the hollow microstructures 140 of FIG. 4 may be comprised of hollow polymer, metal, glass, and/or ceramic centers 145, which may start off as being spherical in shape (but such shape ultimately changes to a shape such as that shown in FIG. 4). In such an example, the hollow centers 145 are coated with metal, such as nickel or iron alloys. In one non-limiting example, the hollow microstructures 140 are comprised of metal, such as nickel, nickel alloy compounds, and the like. At least one metallic coating layer 144 may be disposed on an exterior surface of each center 145. The metallic coating layer 144 may include nickel (Ni), iron, or the like, alone or in combination. The metallic coating layer 144 may be disposed on the exterior surface of the microstructures 140 via electroplating, flame spraying, painting, electroless plating, vapor deposition, or the like. The hollow centers 145 may melt or otherwise disintegrate to become part of the metallic coating layer 144 itself, or melt and turn into a lump of material within the hollow microstructure 140. A plurality of the hollow microstructures 140 may be molded or sintered at a sintering temperature, under pressure, for a molding time, until bonds are formed between the coating layers 144 of adjacent hollow microstructures 140.

The microstructures 140 may be created as described above; however, during sintering, the hollow microstructures 140 (which may start off as substantially spherical or ovoid) may be deformed into deformed microstructures 140, as shown in FIG. 4, where the microstructures 140 become flattened and have greater widths w than heights h. The deformed microstructures 140 may have a generally rectangular cross-section, as shown in FIG. 4, and a generally cuboid shape after being deformed, the deformed microstructures could resemble flattened ovoids. It should be understood that while the microstructures 140 are described as being deformed during the sintering process, it should be appreciated that the microstructures 140 could be deformed during another part of the process of creating the multi-layer thermal barrier 114. Furthermore, a transition layer 22B may be applied to the microstructures 140, as shown and described in FIG. 3.

The hollow microstructures 140 may have a width w of between 5 and 100 μm, between 20 and 100 μm, or between 20-40 μm, by way of example. Similarly, the height h can have similar dimensions, except the height h is less than the width w after the microstructures 140 have been deformed or compressed. It should be appreciated that each of the microstructures 140 do not necessarily have the same width w or height h, as a mixture of heights h and widths w may be provided to create a desired open porosity, e.g., packing density, to provide a desired amount of strength to the insulating layer 122.

The deformed shapes of the microstructures 140 increases the contact area between adjacent microstructures 140, thus increasing the bonding between individual adjacent microstructures 140 and resulting in better heat transfer. Gaps and voids between the microstructures 140 may be reduced or eliminated. Thus, a majority of an exterior surface area of each deformed hollow microstructure 140 is bonded to an adjacent deformed hollow microstructure 140. Deforming the microstructures 140 also creates a smoother surface on the top edge 180 and on the bottom edge 182 of the insulating layer 122, resulting in better contact (an increased contact area) with the sealing layer 124 and with the bonding layer 120, respectively.

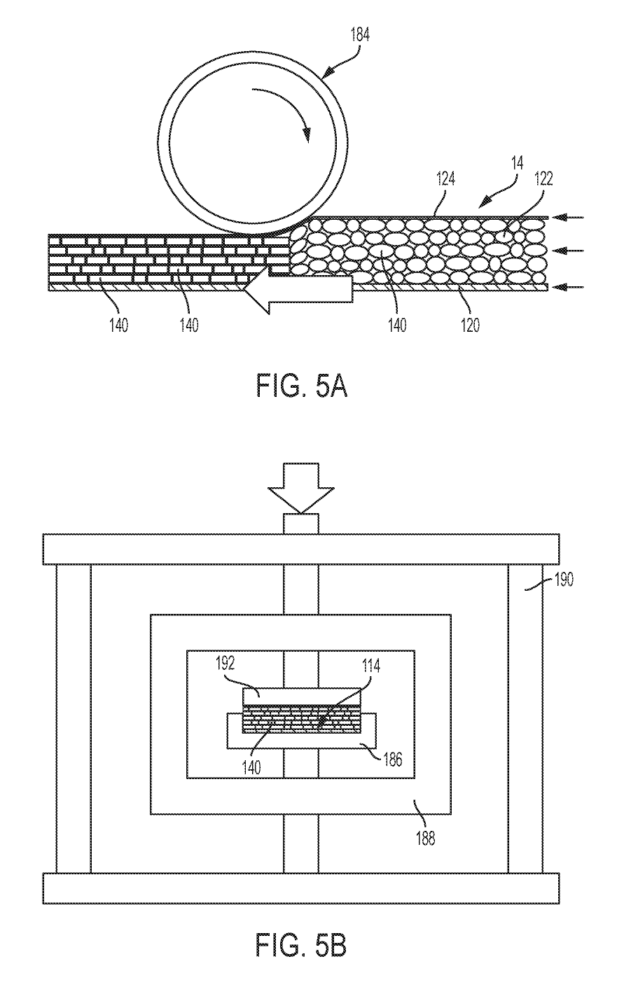

Referring now to FIG. 5A, one option for deforming and compacting the microstructures 140 of the insulating layer 122 is illustrated. After forming and attaching together each of the layers 120, 122, 124, a heated roller apparatus 184 is rolled across the sealing layer 124 to apply a force to the multi-layer thermal barrier 114 and to deform the microstructures 140 until they are flattened as shown on the left side in FIG. 5A. The roller 184 could be selectively heated or placed in an oven before applying force to the multi-layer thermal barrier 114.

In the alternative to assembling the layers 120, 122, 124 prior to rolling the roller 184 across them, the roller 184 may be applied directly to the microstructures 140 prior to disposing the sealing layer 124 on the insulating layer 122. In other words, the sealing layer 124 may be disposed on the insulating layer 122 prior to or after the rolling operation. The sealing layer 124 could alternatively be formed from the top layer of deformed microstructures 140 that may be compressed enough, or even collapsed, to form the sealing layer 124 from the top edge 180 of the insulating layer 122 itself. In the alternative, the sealing layer 124 may be added as a foil, or the sealing layer 124 could be plated or deposited onto the layer 122 of deformed microstructures 140.

Referring to now to FIG. 5B, another option for creating the deformed microstructures 140 is illustrated. The multi-layer thermal barrier 114 is held with a forming die 186 inside a sintering oven 188. The sintering oven 188 may be held by a support structure 190. The force to create the deformation of the microstructures 140 is applied by compressing the multi-layer thermal barrier 114 (or at least the insulating layer 122) between a ram 192 and the forming die 186 to deform the hollow microstructures 140. Such compression with the ram 192 and the forming die 186 may take place during the sintering process. The forming die 186 and/or the ram 192 could be selectively heated or placed in an oven.

In yet another variation, a vacuum force may be applied to the hollow microstructures 140 during, before, or after sintering to deform the hollow microstructures 140.

In any of the variations of forming the multi-layer barrier 114, the process of forming the multi-layer thermal barrier 114 may include heating the insulating layer 122, the bonding layer 120, and the sealing layer 124, such as by sintering.

It should be appreciated that the multi-layer thermal barriers 14, 114 described herein may be applied to components other than present within an internal combustion engine. More specifically, the multi-layer thermal barrier 14, 114 may be applied to components of space crafts, rockets, injection molds, and the like.

The detailed description and the drawings or figures are supportive and descriptive of the disclosure, but the scope of the disclosure is defined solely by the claims. While some examples for carrying out the claimed disclosure have been described in detail, various alternative designs and examples exist for practicing the disclosure defined in the appended claims. Furthermore, the examples shown in the drawings or the characteristics of various examples mentioned in the present description are not necessarily to be understood as examples independent of each other. Rather, it is possible that each of the characteristics described in one example can be combined with one or a plurality of other desired characteristics from other examples, resulting in other examples not described in words or by reference to the drawings. Accordingly, such other examples fall within the framework of the scope of the appended claims.

What is claimed is:

1. A multi-layer thermal barrier comprising:
an insulating layer comprising a plurality of hollow microstructures bonded together; and
a sealing layer bonded to the insulating layer, the sealing layer being non-permeable and configured to seal against the insulating layer, the sealing layer comprising a ceramic material.

2. The multi-layer thermal barrier of claim 1, wherein the ceramic material includes at least one of the following: zirconia, partially stabilized zirconia, silicon nitride, fused silica, and barium-neodymium-titanate (BNT).

3. The multi-layer thermal barrier of claim 2, wherein the sealing layer is substantially comprised of the ceramic material.

4. The multi-layer thermal barrier of claim 2, further comprising a bonding layer configured to be bonded to a metal substrate, the insulating layer being bonded to the bonding layer.

5. The multi-layer thermal barrier of claim 4, wherein the bonding layer comprises at least one of a copper based material, a zinc based material, and an alloy comprising copper and zinc;
wherein each of the plurality of hollow microstructures comprises at least one of a nickel based material and an iron based material;
wherein a thickness of the sealing layer is not greater than 5 microns;
wherein the insulating layer has a thickness between 75 and 300 microns; and
wherein each microstructure of the plurality of microstructures has a width not greater than 100 microns.

6. The multi-layer thermal barrier of claim 1, wherein the insulating layer has a porosity of at least 90%.

7. The multi-layer thermal barrier of claim 1, each hollow microstructure being flattened and having a width and a height, the width being greater than the height.

8. A component comprising a metal substrate presenting a surface, and the multi-layer thermal barrier of claim 4 being bonded to the surface.

9. A multi-layer thermal barrier comprising:
an insulating layer comprising a plurality of deformed hollow microstructures, each deformed hollow microstructure having a width and a height, the width being greater than the height, wherein the plurality of deformed hollow microstructures are bonded together; and
a sealing layer bonded to the insulating layer, the sealing layer being non-permeable and configured to seal against the insulating layer.

10. The multi-layer thermal barrier of claim 9, a majority of an exterior surface area of each deformed hollow microstructure being bonded to an adjacent deformed hollow microstructure of the plurality of deformed hollow microstructures.

11. The multi-layer thermal barrier of claim 10, each deformed hollow microstructure having a generally cuboid shape.

12. The multi-layer thermal barrier of claim 11, further comprising a bonding layer configured to be bonded to a metal substrate, the insulating layer being bonded to the bonding layer.

13. The multi-layer thermal barrier of claim 12, the sealing layer comprising a ceramic material.

14. A component comprising a metal substrate presenting a surface, and the multi-layer thermal barrier of claim 12 being bonded to the surface.

15. An internal combustion engine comprising a component configured to be subjected to combustion gasses, the component having the multi-layer thermal barrier of claim 13 bonded thereto.

16. A method of forming a thermal barrier for use on a component of an internal combustion engine, the method comprising:
providing a plurality of hollow microstructures, each having a diameter in the range of 10 microns to about 50 microns to create an insulating layer; and
applying a force to the insulating layer until each of the hollow microstructures is deformed into a flattened hollow microstructure having a width and a height, the width being greater than the height.

17. The method of claim 16, wherein the step of applying the force includes rolling a heated roller against the plurality of hollow microstructures to deform the plurality of hollow microstructures.

18. The method of claim 16, wherein the step of applying the force includes compressing the plurality of hollow microstructures with a ram and a forming die to deform the plurality of hollow microstructures.

19. The method of claim 16, wherein the step of applying the force includes applying a vacuum force to the plurality of hollow microstructures to deform the plurality of hollow microstructures.

20. The method of claim 16, further comprising:
disposing the insulating layer onto a bonding layer; and
heating the insulating layer and the bonding layer to create the multi-layer thermal barrier.
